(19) United States
(12) Patent Application Publication
(10) Pub. No.: US 2024/0425629 A1
(43) Pub. Date: Dec. 26, 2024

(54) POLYFLUOROALKOXY RESIN AND METHOD OF PREPARING THE SAME

(71) Applicant: JINHUA YONGHE FLUOROCHEMICAL CO., LTD., Jinhua (CN)

(72) Inventors: Jingping ZHAO, Jinhua (CN); Ziliang Guo, Jinhua (CN); Chaofeng Wang, Jinhua (CN); Huajie Tu, Jinhua (CN); Lei Yang, Jinhua (CN); Jian Zhu, Jinhua (CN)

(73) Assignee: JINHUA YONGHE FLUOROCHEMICAL CO., LTD., Jinhua (CN)

(21) Appl. No.: 18/758,446

(22) Filed: Jun. 28, 2024

Related U.S. Application Data
(63) Continuation of application No. PCT/CN2022/118741, filed on Sep. 14, 2022.

(30) Foreign Application Priority Data
Dec. 31, 2021 (CN) 201116639176

(51) Int. Cl. C08F 214/26

(52) U.S. Cl. CPC C08F 214/262; C08F 2800/20

(57) ABSTRACT

A polyfluoroalkoxy resin and a method of preparing the same. The method includes: S1: charging deionized water, an organic solvent, a surfactant, and a chain transfer agent to a polymerization kettle; S2: after heating to a set temperature ranging from 50° C. to 80° C., charging an appropriate amount of polymerization monomer consisting of tetrafluoroethylene and perfluoroalkyl vinyl ether till reaching a set pressure ranging from 0.7 MPa to 1.5 MPa, followed by charging an initiator to start reaction; S3: adding additional polymerization monomer and perfluoroalkyl vinyl ether polymerization promoter, and maintaining the pressure in the polymerization kettle till end of reaction, whereby a polyfluoroalkoxy emulsion is obtained; S4: condensing, washing, and pelleting the polyfluoroalkoxy emulsion from step S3 to obtain the polyfluoroalkoxy resin. The disclosure achieves a PAVE copolymerized rate as high as 65˜90% and can obtain a PFA with a special melting point peak distribution, which has more excellent and stable properties.

### FIELD

The disclosure relates to fluorine chemistry, and more particularly relates to manufacturing of polyfluoroalkoxy.

### BACKGROUND

Polyfluoroalkoxy (PFA) is a copolymer of tetrafluoroethylene (TFE) and perfluoroalkyl vinyl ether (PAVE). The PFA is as excellent as polytetrafluoroethylene (PTFE) in terms of chemical stability, mechanical properties, electrical insulating property, lubricity, non-viscosity, aging resistance, noninflammability, and thermostability; moreover, due to the perfluoroalkoxy straight chain contained in the main chain, the PFA has an enhanced chain flexibility and an improved melt viscosity; therefore, the PFA may be manufactured by a typical thermoplastic forming process.

Thanks to its outstanding properties noted supra, the PFA is widely applied in manufacturing of corrosion-resistant linings for cable sheathing, high-frequency/ultra-high-frequency insulators, and valves and pumps of chemical pipelines, and manufacturing of weld rods for special parts used in the mechanical industry, various anticorrosive materials used in textile and other light industries, and polytetrafluoroethylene anticorrosive linings, as well as in the fields such as the semiconductor industry, the pharmaceutical industry, the electronic and electric equipment industry, the national defense and military industry, and the aerospace industry, etc.

As to synthesis of a PFA resin, various patent literatures have given a detailed description. For example, the U.S. Pat. No. 3,635,926A discloses a process for preparing PFA, specifically comprising: carrying out polymerization at 70° C.˜95° C. under 1.7˜2.4 MPa with ammonium persulfate as the initiator, ammonium perfluorocaprylate as the surfactant, and fluorocarbon as the solvent, whereby a PFA emulsion is obtained. In the Chinese Patent No. 104558365, the mass ratio of perfluoropropoxyethylene (PPVE) to TFE as charged in preparing PFA is about 0.17; however, in the product, the content of PPVE is only 3.7%, with the copolymerized rate being about 22%. Japanese Patent No. 4599640B2 discloses an example of preparing PFA, in which when the mass ratio of PPVE and TFE as charged is about 0.1739, the content of PPVE in the product is only 3.7%, with the copolymerized rate being about 21%. It is seen that the copolymerized rates of PPVE in conventional processes are all very low.

As an essential copolymer monomer in preparing PFA, PAVE has a high cost with a high recovery loss rate. Due to the very low PAVE copolymerized rate and high recovery loss rate, the conventional technologies are not good for industrial production.

### SUMMARY

Disclosed are a polyfluoroalkoxy resin and a method of preparing the same, which yield a high copolymerized rate of PAVE.

The disclosure adopts a technical solution below:

A method of preparing a polyfluoroalkoxy resin, comprising steps of:
S1: charging deionized water, an organic solvent, a surfactant, and a chain transfer agent to a polymerization kettle;
S2: heating to a set temperature ranging from 50° C. to 80° C., then charging a polymerization monomer consisting of tetrafluoroethylene and perfluoroalkyl vinyl ether till reaching a set pressure ranging from 0.7 MPa to 1.5 MPa, followed by charging an initiator to start reaction, wherein a mass ratio of the perfluoroalkyl vinyl ether to the tetrafluoroethylene as charged is in a range from 1:25 to 1:8;
S3: adding additional polymerization monomer and perfluoroalkyl vinyl ether polymerization promoter, and maintaining the pressure in the polymerization kettle till end of reaction, whereby a polyfluoroalkoxy emulsion is obtained, wherein the perfluoroalkyl vinyl ether polymerization promoter is hexafluoropropylene, and a charging amount of the perfluoroalkyl vinyl ether polymerization promoter is in a range from 0.01 wt % to 2 wt % of the polymerization monomer;
S4: condensing, washing, and pelleting the polyfluoroalkoxy emulsion obtained from step S3 to obtain the polyfluoroalkoxy resin.

In some implementations, the mass ratio of the perfluoroalkyl vinyl ether to the tetrafluoroethylene as charged is in a range from 1:15 to 1:8.

In some implementations, the charging amount of the perfluoroalkyl vinyl ether polymerization promoter is in a range from 0.01 wt % to 1.5 wt % of the polymerization monomer.

In some implementations, in a polymerization process, a mass fraction of the tetrafluoroethylene is in a range from 70 wt % to 95 wt %, a mass fraction of the hexafluoropropylene is in a range from 0.1 wt % to 25 wt %, and a mass fraction of perfluoroalkyl vinyl ether is in a range from 2 wt % to 20 wt %.

In some implementations, the perfluoroalkyl vinyl ether is selected from a group consisting of one or a mixture of more of perfluoromethyl vinyl ether, perfluoroethyl vinyl ether, perfluoropropyl vinyl ether, perfluorobutyl vinyl ether and perfluoropentyl vinyl ether.

In some implementations, the hexafluoropropylene is charged all at one time before start of the reaction, the pressure in the polymerization kettle is regulated by controlling charging time of the polymerization monomer while ensuring that the polymerization monomer and the hexafluoropropylene are maintained at desired concentrations in the polymerization kettle; or, the hexafluoropropylene is charged by fractions, and charging speeds of the polymerization monomer and the hexafluoropropylene are controlled such that the polymerization monomer and the hexafluoropropylene are maintained at desired concentrations in the polymerization kettle.

In some implementations, the polyfluoroalkoxy resin obtained from step S4 is subjected to fluorination treatment, so that a number of unstable end groups is below 10.

In the polyfluoroalkoxy resin obtained by the method of preparing a polyfluoroalkoxy resin according to any implementation noted supra, content of perfluoroalkyl vinyl ether is in a range from 3.0 wt % to 10.0 wt %, and content of hexafluoropropylene is in a range from 0.03 wt % to 1.0 wt %; a melt index of the polyfluoroalkoxy resin is in a range of 0.1 g/10 min to 80 g/10 min, and a melting point thereof is in a range from 280° C. to 310° C.

Furthermore, a melting point peak of the polyfluoroalkoxy resin is fractionated by successive self-nucleation and annealing fractionation into eight peaks, which are >317.5° C., 315±2.5° C., 310±2.5° C., 305±2.5° C., 300±2.5° C., 295±2.5° C., 290±2.5° C. and <287.5° C.; peak area of the melting point peak at >317.5° C. accounts for 10% to 35% of total peak area; peak area of the melting point peak at 315±2.5° C. accounts for 0.05% to 3% of the total peak area, peak area of the melting point peak at 310±2.5° C. accounts for 5% to 20% of the total peak area, a sum of the peak areas of the melting point peak at 305±2.5° C., 300±2.5° C., 295±2.5° C., 290±2.5° C. accounts for 35% to 70% of the total peak area, and peak area of the melting point peak at <287.5° C. accounts for 0.01% to 8% of the total peak area.

With hexafluoropropylene as the PAVE polymerization promoter and by adjusting the relative polymerization speed of PAVE through controlling charging time of hexafluoropropylene and mass fraction of the hexafluoropropylene in the polymerization kettle, the present disclosure enables control of the mass fractions and arrangements of the hexafluoropropylene and the PAVE in the polymerization chain, resulting in a PAVE copolymerized rate as high as 65˜90%; meanwhile, the process as disclosed here can obtain a PFA with a special melting point peak distribution, which has more excellent and stable properties.

The specific technical solutions and benefits of the disclosure will be described in detail through the implementations infra with reference to the accompanying drawings.

### BRIEF DESCRIPTION OF THE DRAWINGS

Hereinafter, the disclosure will be further described through implementations with reference to the accompanying drawings:

FIG. 1a is a schematic diagram illustrating a peak value of PFA obtained from comparative example 1;

FIG. 1b is a schematic diagram of melting point peak distribution of PFA obtained from comparative example 1;

FIG. 2a is a schematic diagram illustrating a peak value of PFA obtained from example 1;

FIG. 2b is a schematic diagram of melting point peak distribution of PFA obtained from example 1;

FIG. 3a is a schematic diagram illustrating a peak value of PFA obtained from example 2;

FIG. 3b is a schematic diagram of melting point peak distribution of PFA obtained from example 2;

FIG. 4a is a schematic diagram illustrating a peak value of PFA obtained from example 3;

FIG. 4b is a schematic diagram of melting point peak distribution of PFA obtained from example 3;

FIG. 5a is a schematic diagram illustrating a peak value of PFA obtained from example 4;

FIG. 5b is a schematic diagram of melting point peak distribution of PFA obtained from example 4;

FIG. 6 is a rheological analysis diagram of PFA obtained from example 3;

FIG. 7 is a rheological analysis diagram of PFA obtained from example 5;

FIG. 8 is an NMR analysis diagram of PFA obtained from example 4;

FIG. 9 is an NMR analysis diagram of PFA obtained from example 5; and

FIGS. 10, 11, 12, 13, and 14 are annexes of drawings that respectively correspond one by one to the specific parameters of the points in the FIGS. 1b, 2b, 3b, 4b, and 5b.

### DETAILED DESCRIPTION OF EMBODIMENTS

Hereinafter, the technical solutions of the disclosure will be described in a clear and comprehensive manner through examples with reference to the accompanying drawings. It is apparent that the examples are only some implementations of the disclosure, not all of them. The description of at least one example infra is only illustrative, not constituting any limitation to the present disclosure or its application or use. Other examples obtained by those skilled in the art based on the examples described herein without exercise of inventive work all fall within the protection scope of the disclosure.

The present disclosure provides a method of preparing polyfluoroalkoxy (PFA), in which hexafluoropropylene is used as a perfluoroalkyl vinyl ether (PAVE) polymerization promoter, and PAVE polymerization speed is adjusted by controlling charging time of the hexafluoropropylene and mass fraction of the hexafluoropropylene in the polymerization kettle, whereby the copolymerized rate of PAVE in the polymerization product is increased; the method of preparing PFA comprises the following steps:

Step 1: deionized water, an organic solvent, a surfactant, and a chain transfer agent are charged to an anaerobic polymerization kettle according to a certain ratio.

For example, 10,000 parts of the deionized water, 20˜1,000 parts of the organic solvent, 2˜200 parts of the surfactant, and 0.1˜200 parts of the chain transfer agent are charged to the polymerization kettle.

It may be understood that, various substances common in the art may be used as the organic solvent, the surfactant, and the chain transfer agent. Since the relative amount varies greatly with the charging amount of each substance, the parts of the substances charged will not be quantized one by one, which may refer to the example amounts in the examples described below.

Step 2: after the polymerization kettle is heated to a set temperature ranging from 50° C. to 80° C., a polymerization monomer consisting of tetrafluoroethylene (TFE) and perfluoroalkyl vinyl ether (PAVE) is charged till a set pressure ranging from 0.7˜1.5 MPa; now, in the polymerization kettle, the mass fraction of TFE is 70˜95 wt % and the mass fraction of PAVE is 2-20 wt %; and then an initiator is charged to start reaction;

Step 3: additional polymerization monomer and PAVE polymerization promoter are added, with the pressure in the polymerization kettle being maintained at the set pressure 0.7˜1.5 MPa till end of the reaction, thereby obtaining a PFA emulsion.

In this step, the PAVE polymerization promoter is hexafluoropropylene, which can increase the copolymerized rate of PAVE. By adjusting the charging time of hexafluoropropylene and its mass fraction in the polymerization kettle to control PAVE distribution on the polymerization chain, a target melting point peak distribution of the PFA resin is obtained. For example, in comparative example 1, without charging hexafluoropropylene as the PAVE polymerization promoter, the copolymerized rate of PAVE is about 35%, and the peak area at 320±2.5° C. in the melting point peak exceeds 50% of the total peak area, so that the performance is seriously degraded; while in example 1, by adjusting the charging timing and amount of hexafluoropropylene, the hexafluoropropylene concentration in the polymerization kettle is controlled, so that the copolymerized rate of PAVE is increased while the melting point peak distribution is controlled, whereby the performance is optimized.

In this step, the TFE and the PAVE may be charged continuously or by fractions; for example, additional polymerization monomer is added each time the pressure in the polymerization kettle drops by 0.1 MPa, and in conjunction with appropriate charging time of hexafluoropropylene, an ideal melting point peak distribution can also be obtained.

In this step, the polymerization monomer consists of TFE and PAVE, and the overall mass ratio of the PAVE to the TFE as charged in the reaction process is in a range from 1:25 to 1:8. It may be understood that the PAVE and the TFE are usually weighed and charged separately, and it is only required to ensure that their respective total charging amounts fall within the range.

In this step, the PAVE is selected from a group consisting of one or a mixture of more of perfluoromethyl vinyl ether, perfluoroethyl vinyl ether, perfluoropropyl vinyl ether, perfluorobutyl vinyl ether and perfluoropentyl vinyl ether.

In this step, hexafluoropropylene may be charged all at one time before start of the reaction or charged by fractions during the reaction process, as illustrated in example 2 and example 3. In example 3, hexafluoropropylene is charged all at one time at start of the polymerization; however, by controlling charging time of the TFE and the PAVE and regulating the pressure in the polymerization kettle to a range from 0.7 MPa to 1.5 MPa while ensuring that the TFE, the PAVE, and the hexafluoropropylene in the polymerization kettle are maintained at desired concentrations, an ideal melting point peak distribution and a high PAVE copolymerized rate can also be obtained.

In this step, hexafluoropropylene may also be charged continuously; however, it is required that respective charging speeds of the TFE, the PAVE, and the hexafluoropropylene are controlled ensuring that they are maintained at desired concentrations in the polymerization kettle, as illustrated in example 4. Herein, the hexafluoropropylene may be first mixed with the polymerization monomer before charging, or may be charged separately.

In this step, the desired concentrations are such that in the polymerization kettle, the mass fraction of TFE is 70˜95 wt %, the mass fraction of hexafluoropropylene is 0.1˜20 wt %, and the mass fraction of PAVE is 2˜20 wt %. The charging amount of the PAVE polymerization promoter is 0.01 wt %˜2 wt % of the polymerization monomer.

Step 4: the obtained PFA emulsion is condensed, washed, and pelleted to obtain PFA resin.

In the disclosure, a melt index of the obtained PFA resin is in a range from 0.1 g/10 min to 80 g/10 min;

In the disclosure, a melting point of the obtained PFA is in a range from 280° C. to 310° C.;

In the disclosure, a mechanical property of the obtained PFA resin is in a range from 30 MPa to 38 MPa;

In the disclosure, an elongation at break of the obtained PFA resin is in a range from 300% to 410%;

In the disclosure, PAVE content in the obtained PFA resin is in a range from 3.0 wt % to 10.0 wt %;

In the disclosure, hexafluoropropylene content in the obtained PFA resin is in a range from 0.03% to 1.0%.

The PFA resin obtained from step 4 further is subjected to fluorination treatment, so that the number of its unstable end groups is below 10.

### Test Method

### 1. Measurement of Melt Flow Rate

According to the method set forth in ASTMD 1238, the test is performed using a melt flow rate tester (RL-Z1B1, Shanghai S.R.D Scientific Instrument Co., Ltd). The test temperature is 372° C., and the test load is 5 kg.

### 2. Measurement of Mechanical Property

According to the method set forth in ASTMD 638, the tensile strength and the elongation at break of the molded specimen are tested by a universal testing machine (ETM503A, Shenzhen Wance Testing Machine Co., Ltd.). The environment temperature of the test is 23±2° C., the tensile speed is 50 mm/min±5 mm/min, and the inter-grip distance is 24 mm.

### 3. Melting Point

According to the method set forth in ASTMD 3418, the melting point of the PFA is measured using a differential scanning calorimetry (DSC823e, METTLER): a 20 mg±0.5 mg sample is weighed and heated to 400° C. at a heating rate of 10° C./min under an atmosphere of nitrogen; the peak temperature of the DSC melting peak is taken as the melting point of the polymer.

### 4. Measurement of PAVE Content

A 0.05˜0.3 mm-thick sheet is prepared by a known process and scanned by a Fourier Transform infrared spectroscopy (Spectrum Two, PerkinElmer); the PAVE content is calculated based on the absorbance (A) at the characteristic peak by an equation given below, where the perfluoromethyl vinyl ether (PMVE) content is determined based on the absorbance at the wave number 893 cm-1, the perfluoroethyl vinyl ether (PEVE) content is determined based on the absorbance at the wave number 1089 cm-1, and the perfluoropropyl vinyl ether (PPVE) is determined based on the absorbance at the wave number 990 cm-1:

PMVE content wt %=7×(A1/A0);

PEVE content wt %=0.75+1.28×(A2/A0);

PPVE content wt %=0.97×(A3/A0);

where A0 denotes the absorbance at the wave number 2353 cm-1, A1 denotes the absorbance at the wave number 893 cm-1, A2 denotes the absorbance at the wave number 1089 cm-1, and A3 denotes the absorbance at the wave number 990 cm-1.

Presence of another modified monomer would affect measurement of the characteristic absorbance of PPVE; in this case, it is measured by NMR (Nuclear Magnetic Resonance).

### 5. Measurement of Hexafluoropropylene Content

The hexafluoropropylene content is measured by a fluorine nuclear magnetic resonance spectroscopy.

### 6. Measurement of Folding Endurance

A 0.2 mm-thick sheet is prepared by a known plastic manufacturing process and cut into a 120 mm*15 mm elongated bar. According to the method set forth in ASTM D2176, the folding endurance is measured by a M.I.T. folding endurance tester (PN-NZ135, PNSHAR) under a load of 1 kg and a bending speed of 175 times/min.

### 7. Successive Self-Nucleation and Annealing (SSA) Fractionation

The SSA fractionation is measured by a differential scanning calorimetry (DSC823e, METTLER). A 20 mg±0.5 mg sample is weighed, and under the atmosphere of nitrogen, heated from 200° C. to 400° C. at a heating rate of 10° C./min and maintained at the temperature for 30 min, then cooled to 200° C. at a cooling rate of 10° C./min and maintained at the temperature for 30 min, then heated to 320° C. at a heating rate of 10° C./min and maintained at the temperature for 30 min, then cooled to 200° C. at a cooling rate of 10° C./min and maintained at the temperature for 30 min, then heated to 315° C. at a heating rate of 10° C./min and maintained at the temperature for 30 min, then cooled to 200° C. at a cooling rate of 10° C./min and maintained at the temperature for 30 min, then heated to 310° C. at a heating rate of 10° C./min and maintained at the temperature for 30 min, then cooled to 200° C. at a cooling rate of 10° C./min and maintained at the temperature for 30 min, then heated to 305° C. at a heating rate of 10° C./min and maintained at the temperature for 30 min, then cooled to 200° C. at a cooling rate of 10° C./min and maintained at the temperature for 30 min, then heated to 300° C. at a heating rate of 10° C./min and maintained at the temperature for 30 min, then cooled to 200° C. at a cooling rate of 10° C./min and maintained at the temperature for 30 min, then heated to 295° C. at a heating rate of 10° C./min and maintained at the temperature for 30 min, then cooled to 200° C. at a cooling rate of 10° C./min and maintained at the temperature for 30 min, then heated to 290° C. at a heating rate of 10° C./min and maintained at the temperature for 30 min, then cooled to 200° C. at a cooling rate of 10° C./min and maintained at the temperature for 30 min, then heated to 285° C. at a heating rate of 10° C./min and maintained at the temperature for 30 min, then cooled to 200° C. at a cooling rate of 10° C./min and maintained at the temperature for 30 min, then heated to 280° C. at a heating rate of 10° C./min and maintained at the temperature for 30 min, then cooled to 50° C. at a cooling rate of 10° C./min and maintained at the temperature for 30 min, and then heated to 400° C. at a heating rate of 10° C./min; the thermograph of the last heating is taken to obtain the peak areas corresponding to respective temperature segments from 200° C. to 350° C.

### Comparative Example 1

Step 1: 10L deionized water, 100 g fluorocarbon solvent, 20 g dispersant X were charged to a 20L horizontal reaction kettle with an agitator, then the reaction kettle was evacuated till oxygen content in the reaction kettle was below 30 ppm;
Step 2: 0.4 g high-purity hydrogen was charged to the reaction kettle and heated to 60° C.; then, 100 g PPVE and an appropriate amount of TFE were charged to the reaction kettle till the pressure in the reaction kettle reached 1.0 MPa;
Step 3: 5 g potassium peroxodisulfate was charged to start reaction, and the pressure was stabilized at 1.0 MPa˜1.2 MPa when additional TFE and PPVE were continuously added;
Step 4: the reaction stopped when additional 4000 g TFE and 200 g PPVE in total were added, followed by evacuating unreacted gas in the reaction kettle, thereby obtaining a PFA emulsion;
Step 5: the PFA emulsion obtained from step 4 was condensed, washed, and pelleted to obtain 3,892 g PFA resin with a number of unstable end groups being below 50;
Step 6: the PFA resin obtained from step 5 was subjected to fluorination treatment so that the number of its unstable end groups was below 10.

The analysis and test results of the PFA resin obtained from comparative example 1 are shown in Table 1.

TABLE 1

| Item | Resultant Data |
|---|---|
| Melt Index (g/10 min) | 4.9 |
| Melting point (° C.) | 307.6 |
| Tensile strength (MPa) | 28.7 |
| Elongation at break (%) | 305 |
| PAVE content (%) | 2.73 |
| HFP content (%) | 0 |
| Bending endurance (times) | 60,000 |
| Critical shear rate (s⁻¹) | 35 |
| PAVE copolymerized rate (%) | 35.42 |

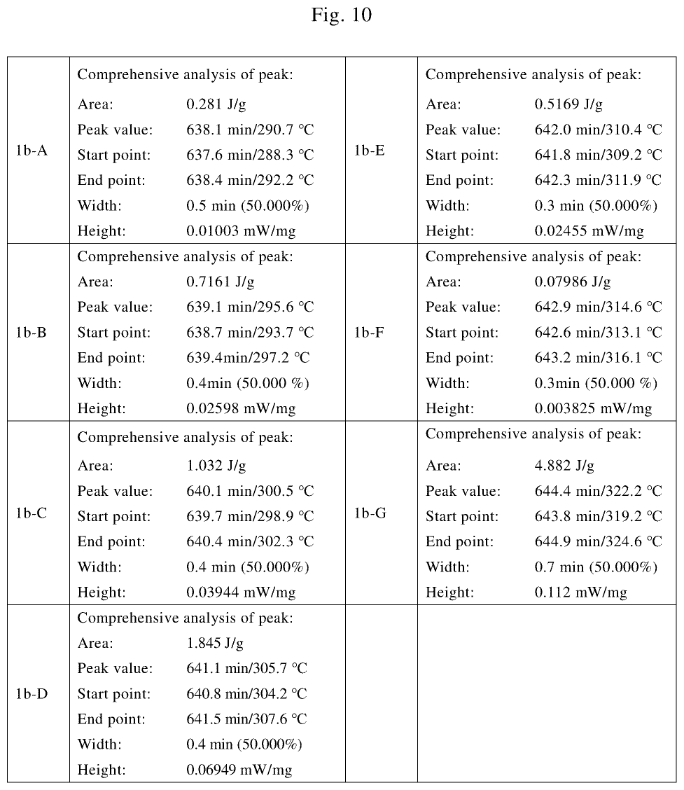

The peak value and melting point peak distribution are shown in FIG. 1a, FIG. 1b, and FIG. 10.

### Example 1

Step 1: 10L deionized water, 100 g fluorocarbon solvent, 20 g dispersant X were charged to a 20L horizontal reaction kettle with an agitator, then the reaction kettle was evacuated till oxygen content in the reaction kettle was below 30 ppm;
Step 2: 0.4 g high-purity hydrogen was charged to the reaction kettle and heated to 60° C.; then, 100 g PPVE and an appropriate amount of TFE were charged to the reaction kettle till the pressure in the reaction kettle reached 1.0 MPa;
Step 3: 5 g potassium peroxodisulfate was charged to start reaction; the pressure was stabilized at 1.0 MPa ˜1.2 MPa when additional TFE and the PPVE were continuously added; when additional 500 g TFE was added, additional 4 g hexafluoropropylene was added all at one time; when additional 2,000 g TFE was added, additional 10 g hexafluoropropylene was added all at one time; when additional 3,300 g TFE was added, additional 6 g hexafluoropropylene was added all at one time;
Step 4: the reaction stopped when additional 4,000 g TFE, 150 g PPVE, and additional 20 g hexafluoropropylene in total were added, followed by evacuating the unreacted gas in the reaction kettle, thereby obtaining a PFA emulsion;
Step 5: the PFA emulsion obtained from step 4 was condensed, washed, and pelleted to obtain 3,866 g PFA resin with a number of unstable end groups being below 50;
Step 6: the PFA resin obtained from step 5 was subjected to fluorination treatment so that the number of its unstable end groups was below 10.

The analysis and test results of the PFA resin obtained from example 1 are shown in Table 2.

TABLE 2

| Item | Resultant Data |
|---|---|
| Melt Index (g/10 min) | 6.2 |
| Melting point (° C.) | 304.1 |
| Tensile strength (MPa) | 35.6 |
| Elongation at break (%) | 388 |
| PAVE content (%) | 4.82 |
| HFP content (%) | 0.31 |
| Bending endurance (times) | 610,000 |
| Critical shear rate (s⁻¹) | 50 |
| PAVE copolymerized rate (%) | 74.54 |

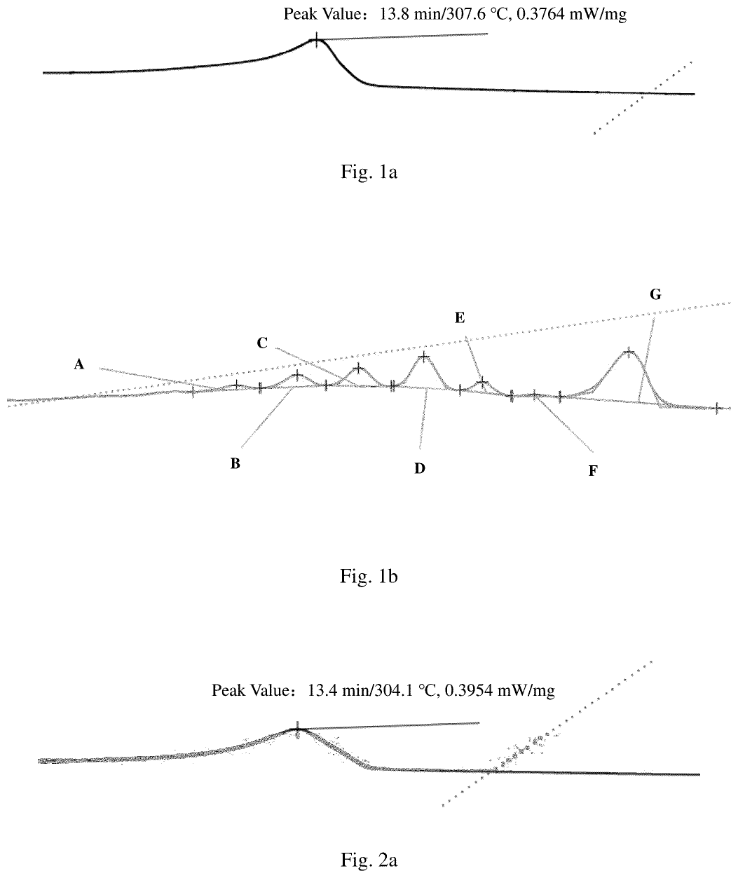

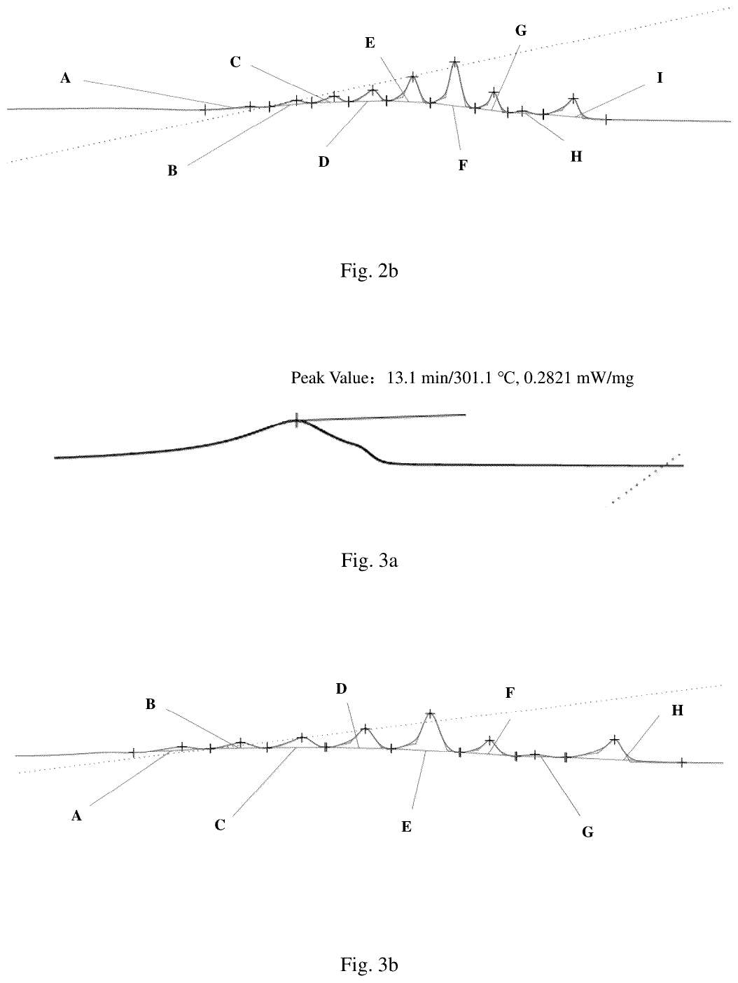

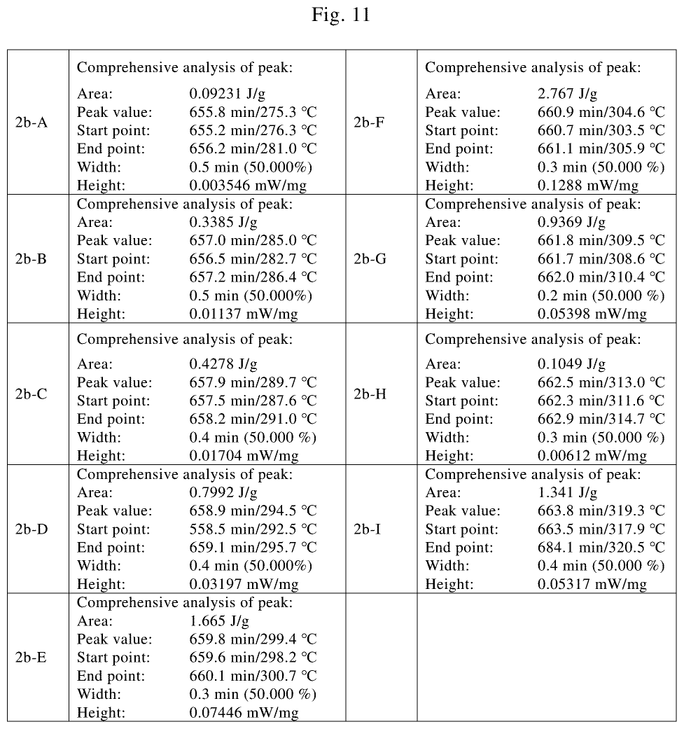

The peak value and melting point peak distribution are shown in FIG. 2a, FIG. 2b, and FIG. 11.

### Example 2

Step 1: 10L deionized water, 100 g fluorocarbon solvent, 20 g mixed dispersant disclosed in Patent No. CN106366230 issued to the applicant of the disclosure (hereinafter referred to as dispersant X) were charged to a 20L horizontal reaction kettle with an agitator, then the reaction kettle was evacuated till an oxygen content in the reaction kettle is below 30 ppm;
Step 2: 0.4 g high-purity hydrogen was charged to the reaction kettle and heated to 60° C.; then, 40 g PMVE, 60 g PPVE, and an appropriate amount of TFE were charged to the reaction kettle till the pressure in the reaction kettle reached 1.0 MPa;
Step 3: 5 g potassium peroxodisulfate was charged to start reaction, where additional TFE and PPVE were added each time the pressure in the polymerization kettle dropped by 0.1 MPa, so as to restore the pressure to 1.0 MPa; when additional 1,000 g TFE was added, additional 6 g hexafluoropropylene was added all at one time; when additional 2,000 g TFE was added, additional 3 g hexafluoropropylene was added all at one time, and when additional 3,000 g TFE was added, additional 8 g hexafluoropropylene was added all at one time;
Step 4: the reaction stopped when additional 4,000 g TFE, additional 170 g PPVE, and additional 17 g hexafluoropropylene in total were added, followed by evacuating unreacted gas in the reaction kettle, thereby obtaining a PFA emulsion;
Step 5: the PFA emulsion obtained from step 4 was condensed, washed, and pelleted to obtain 3893 g PFA resin with a number of unstable end groups being below 50;
Step 6: the PFA resin obtained from step 5 was subjected to fluorination treatment so that the number of its unstable end groups was below 10.

The analysis and test results of the PFA resin obtained from example 2 are shown in Table 3.

TABLE 3

| Item | Resultant Data |
|---|---|
| Melt Index (g/10 min) | 10.4 |
| Melting point (° C.) | 301.1 |
| Tensile strength (MPa) | 34.3 |
| Elongation at break (%) | 379 |
| PAVE content (%) | 5.05 |
| HFP content (%) | 0.32 |
| Bending endurance (times) | 130,000 |
| Critical shear rate (s⁻¹) | 120 |
| PAVE copolymerized rate (%) | 72.81 |

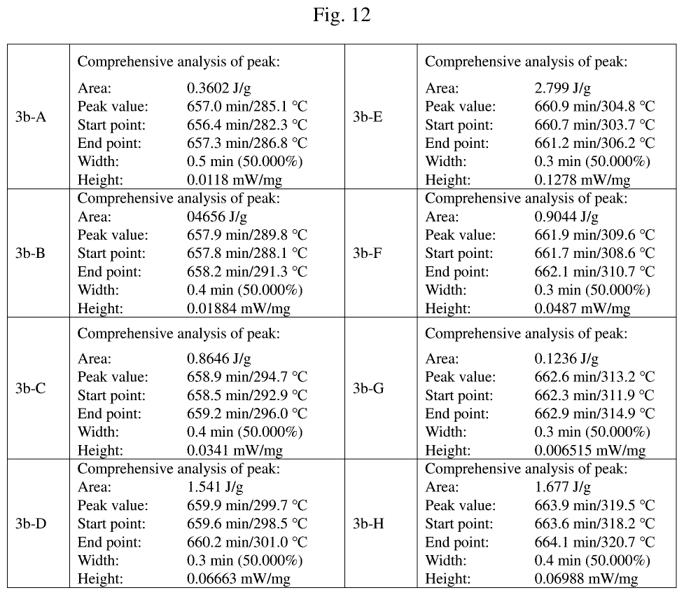

The peak value and melting point peak distributions are shown in FIG. 3a, FIG. 3b, and FIG. 12.

### Example 3

Step 1: 10L deionized water, 100 g fluorocarbon solvent, 20 g dispersant X were charged to a 20L horizontal reaction kettle with an agitator, then the reaction kettle was evacuated till an oxygen content in the reaction kettle was below 30 ppm;
Step 2: 0.5 g high-purity hydrogen was charged to the reaction kettle and heated to 60° C.; then, 45 g PEVE, 75 g PPVE, 20 g hexafluoropropylene, and an appropriate amount of TFE were charged to the reaction kettle till the pressure in the reaction kettle reached 1.0 MPa;
Step 3: 5 g potassium peroxodisulfate was charged to start reaction, where an appropriate amount of polymerization monomer was additionally added each time when the pressure in the polarization kettle dropped by 0.1 MPa˜0.3 MPa so that the pressure in the polymerization kettle was restored to 1.0 MPa˜1.2 MPa, ensuring that the TFE, PPVE, and hexafluoropropylene in the polymerization kettle were kept within respective ranges of desired concentrations;
Step 4: the reaction stopped when additional 4,000 g TFE and additional 190 g PPVE were added, followed by evacuating the unreacted gas in the reaction kettle, thereby obtaining a PFA emulsion;
Step 5: the PFA emulsion obtained from step 4 was condensed, washed, and pelleted to obtain 3,926 g PFA resin with a number of unstable end groups being below 50;
Step 6: the PFA resin obtained from step 5 was subjected to fluorination treatment so that the number of its unstable end groups was below 10.

The analysis and test results of the PFA resin obtained from example 3 are shown in Table 4.

TABLE 4

| Item | Resultant Data |
|---|---|
| Melt Index (g/10 min) | 18.1 |
| Melting point (° C.) | 297.5 |
| Tensile strength (MPa) | 32.6 |
| Elongation at break (%) | 366 |
| PAVE content (%) | 5.41 |
| HFP content (%) | 0.38 |
| Bending endurance (times) | 70,000 |
| Critical shear rate (s⁻¹) | 150 |
| PAVE copolymerized rate (%) | 68.52 |

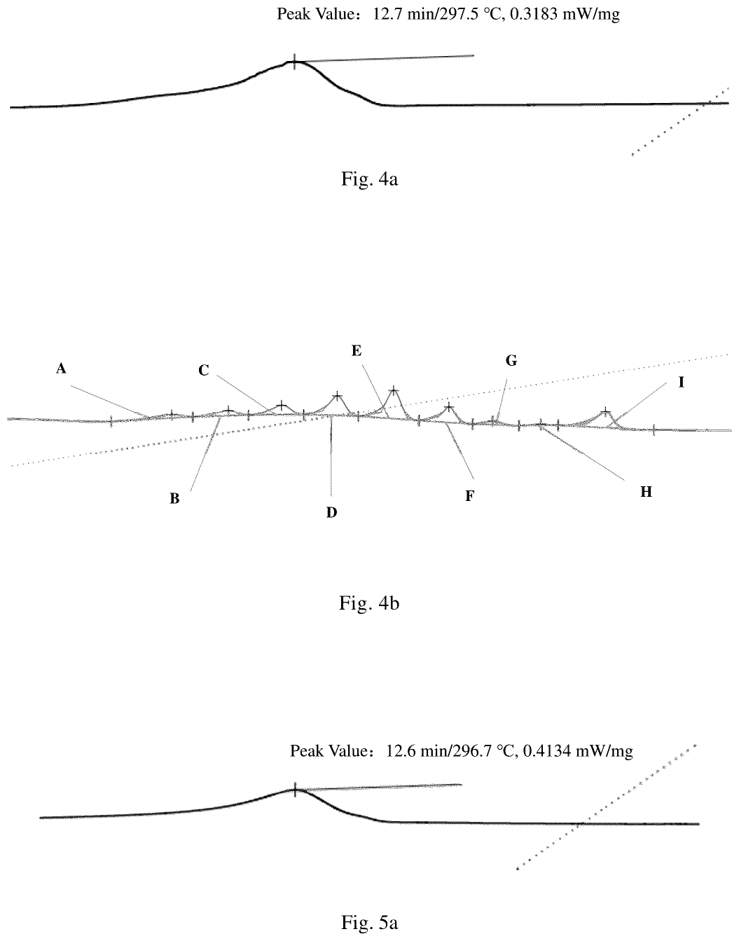

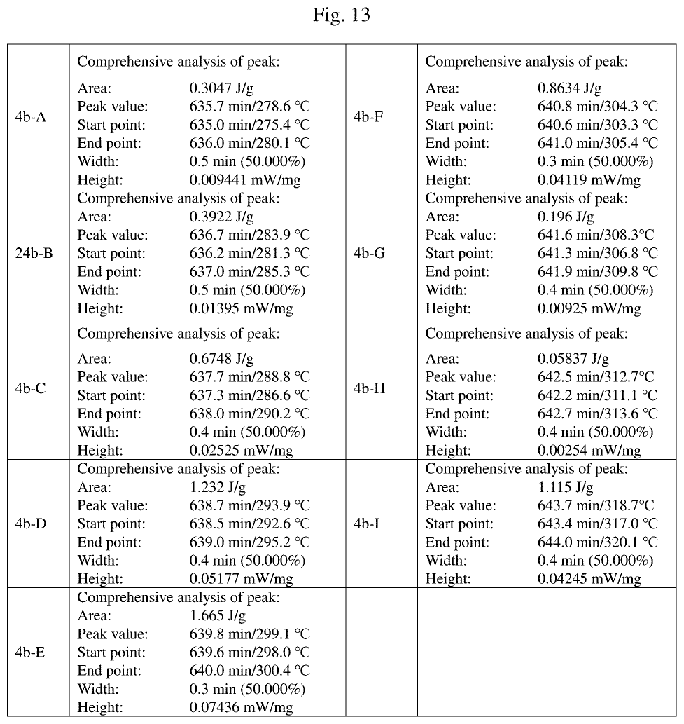

The peak value and melting point peak distributions are shown in FIG. 4a, FIG. 4b, and FIG. 13, and the rheological analysis is shown in FIG. 6.

### Example 4

Step 1: 10L deionized water, 100 g fluorocarbon solvent, 20 g dispersant X were charged to a 20L horizontal reaction kettle with an agitator, then the reaction kettle was evacuated till an oxygen content in the reaction kettle was below 30 ppm;
Step 2:0.9 g high-purity hydrogen was charged to the reaction kettle and heated to 60° C.; then, 150 g PPVE and an appropriate amount of TFE were charged to the reaction kettle till the pressure in the reaction kettle reached 1.0 MPa;
Step 3: 6 g potassium peroxodisulfate was charged to start reaction, and additional TFE, PPVE, and hexafluoropropylene were continuously added to the polymerization kettle to maintain the pressure in the polymerization kettle at 0.9 MPa˜1.2 MPa;
Step 4: the reaction stopped when additional 4,000 g TFE, additional 260 g PPVE, and additional 65 g hexafluoropropylene were added, followed by evacuating the unreacted gas in the reaction kettle, thereby obtaining a PFA emulsion;
Step 5: the PFA emulsion obtained from step 4 was condensed, washed, and pelleted to obtain 4,102 g PFA resin with a number of unstable end groups being below 50;
Step 6: the PFA resin obtained from step 5 was subjected to fluorination treatment so that the number of its unstable end groups was below 10.

The analysis and test results of the PFA resin obtained from example 4 are shown in Table 5.

TABLE 5

| Item | Resultant Data |
|---|---|
| Melt Index (g/10 min) | 58.7 |
| Melting point (° C.) | 291 |
| Tensile strength (MPa) | 30.3 |
| Elongation at break (%) | 379 |
| PAVE content (%) | 8.12 |
| HFP content (%) | 0.56 |
| Bending endurance (times) | 4,000 |
| Critical shear rate (s⁻¹) | 400 |
| PAVE copolymerized rate (%) | 81.24 |

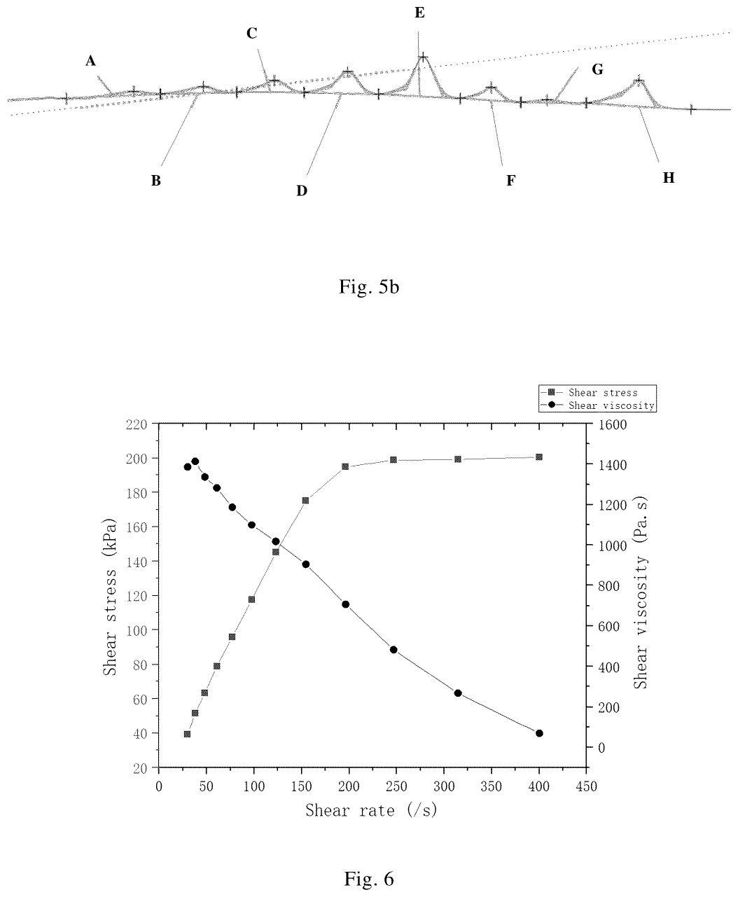

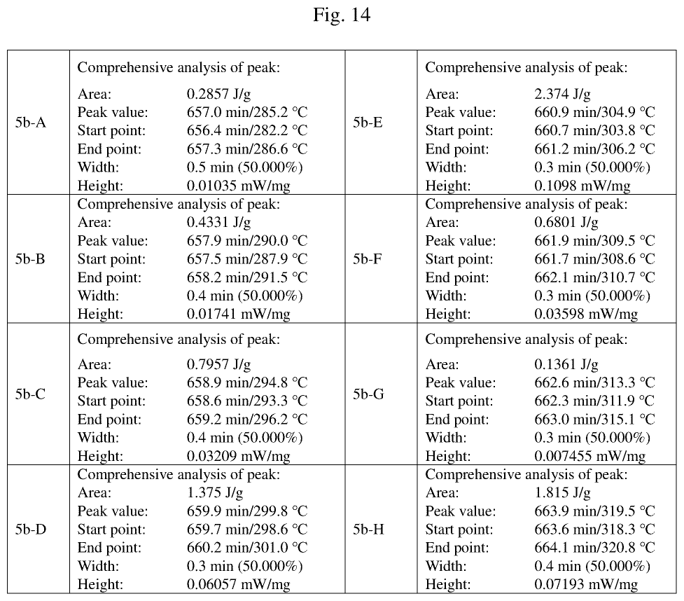

The peak value and melting point peak distribution are shown in FIG. 5a, FIG. 5b, and FIG. 14 and the NMR analysis is shown in FIG. 8.

### Example 5

Step 1: 10L deionized water, 100 g fluorocarbon solvent, 20 g dispersant X were charged to a 20L horizontal reaction kettle with an agitator, then the reaction kettle was evacuated till an oxygen content in the reaction kettle was below 30 ppm;
Step 2: 0.5 g high-purity hydrogen was charged to the reaction kettle and heated to 60° C.; then, 140 g PPVE and an appropriate amount of TFE were charged to the reaction kettle till the pressure in the reaction kettle reached 1.0 MPa;
Step 3: 5 g potassium peroxodisulfate was charged to start reaction, the pressure was maintained at 1.0 MPa ˜1.2 MPa when additional TFE and the PPVE were continuously added; when additional 500 g TFE was added, additional 8 g hexafluoropropylene was added all at one time; when additional 2,000 g TFE was added, additional 16 g hexafluoropropylene was added all at one time; when additional 3,300 g TFE was added, additional 6 g hexafluoropropylene was added all at one time;
Step 4: the reaction stopped when additional 4,000 g TFE, 200 g PPVE, and 30 g hexafluoropropylene were added, followed by evacuating the unreacted gas in the reaction kettle, thereby obtaining a PFA emulsion;
Step 5: the PFA emulsion obtained from step 4 was condensed, washed, and pelleted to obtain 3,955 g PFA resin with a number of unstable end groups being below 50;
Step 6: the PFA resin obtained from step 5 was subjected to fluorination treatment so that the number of its unstable end groups was below 10.

The analysis and test results of the PFA resin obtained from example 5 are shown in Table 6.

TABLE 6

| Item | Resultant Data |
|---|---|
| Melt Index (g/10 min) | 25.2 |
| Melting point (° C.) | 296.7 |
| Tensile strength (MPa) | 30.3 |
| Elongation at break (%) | 379 |
| PAVE content (%) | 5.89 |
| HFP content (%) | 0.52 |
| Critical shear rate (s⁻¹) | 250 |
| PAVE copolymerized rate (%) | 68.51 |

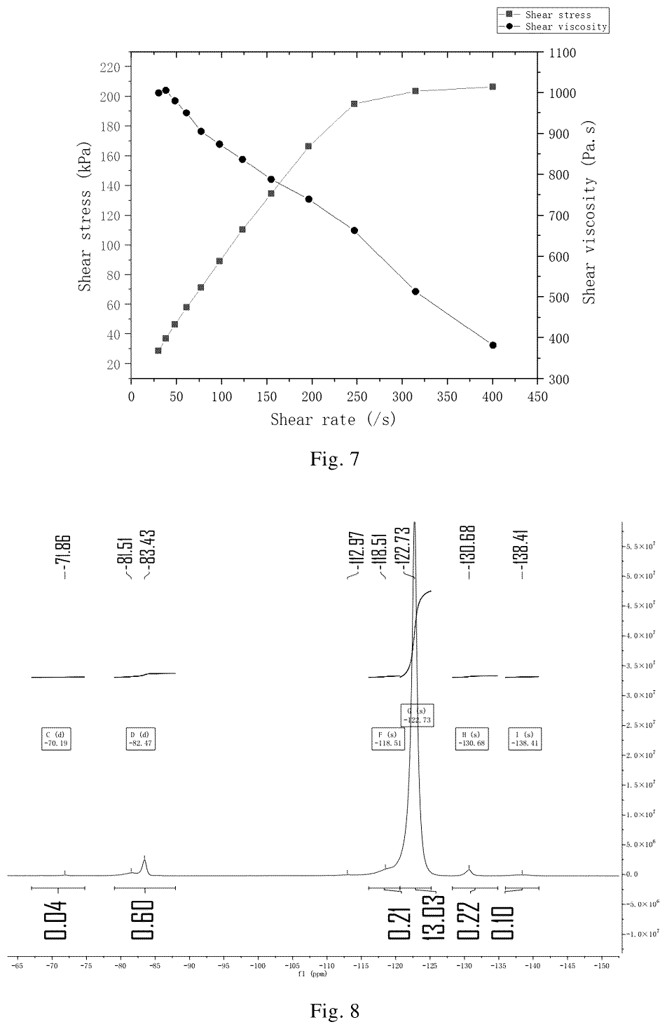

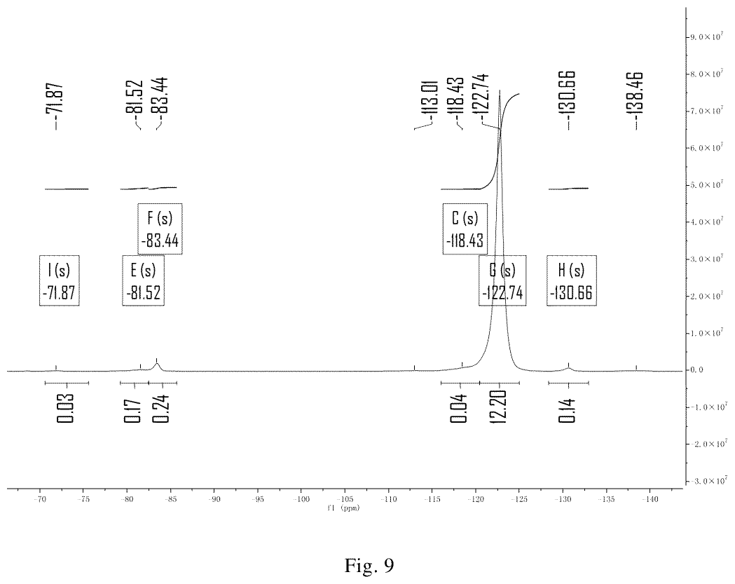

The rheological analysis and NMR analysis are shown in FIG. 7 and FIG. 9.

The examples indicate that the preparing method according to the disclosure can obtain a PFA with a special melting point peak distribution, which has excellent and stable properties.

What have been described above are only embodiments of the disclosure; however, the protection scope of the disclosure is not limited thereto. A person skilled in the art should understand that the disclosure includes, but is not limited to, the contents described in the drawings and the embodiments. Any modifications without departing from the functions and structural principles of the disclosure will be included within the scope of the claims.

1-10. (canceled)

11. A method of preparing a polyfluoroalkoxy resin, comprising:
charging deionized water, an organic solvent, a surfactant, and a chain transfer agent to a polymerization kettle;
heating to a set temperature ranging from 50° C. to 80° C., then charging a polymerization monomer consisting of tetrafluoroethylene and perfluoroalkyl vinyl ether till reaching a set pressure ranging from 0.7 MPa to 1.5 MPa, followed by charging an initiator to start reaction, wherein a mass ratio of the perfluoroalkyl vinyl ether to the tetrafluoroethylene as charged is in a range from 1:25 to 1:8;
S3: adding additional polymerization monomer and perfluoroalkyl vinyl ether polymerization promoter, and maintaining the pressure in the polymerization kettle till end of reaction, whereby a polyfluoroalkoxy emulsion is obtained, wherein the perfluoroalkyl vinyl ether polymerization promoter is hexafluoropropylene, and a charging amount of the perfluoroalkyl vinyl ether polymerization promoter is in a range from 0.01 wt % to 2 wt % of the polymerization monomer;
S4: condensing, washing, and pelleting the obtained polyfluoroalkoxy emulsion to obtain the polyfluoroalkoxy resin.

12. The method of preparing a polyfluoroalkoxy resin of claim 11, wherein the mass ratio of the perfluoroalkyl vinyl ether to the tetrafluoroethylene as charged is in a range from 1:15 to 1:8.

13. The method of preparing a polyfluoroalkoxy resin of claim 11, wherein the charging amount of the perfluoroalkyl vinyl ether polymerization promoter is in a range from 0.01 wt % to 1.5 wt % of the polymerization monomer.

14. The method of preparing a polyfluoroalkoxy resin of claim 11, wherein in a polymerization process, a mass fraction of the tetrafluoroethylene is in a range from 70 wt % to 95 wt %, a mass fraction of the hexafluoropropylene is in a range from 0.1 wt % to 25 wt %, and a mass fraction of perfluoroalkyl vinyl ether is in a range from 2 wt % to 20 wt %.

15. The method of preparing a polyfluoroalkoxy resin of claim 11, wherein the perfluoroalkyl vinyl ether is selected from a group consisting of one or a mixture of more of perfluoromethyl vinyl ether, perfluoroethyl vinyl ether, perfluoropropyl vinyl ether, perfluorobutyl vinyl ether and perfluoropentyl vinyl ether.

16. The method of preparing a polyfluoroalkoxy resin of claim 11, wherein the hexafluoropropylene is charged all at one time before start of the reaction, the pressure in the polymerization kettle is regulated by controlling charging time of the polymerization monomer while ensuring that the polymerization monomer and the hexafluoropropylene are maintained at desired concentrations in the polymerization kettle; or, the hexafluoropropylene is charged by fractions, and charging speeds of the polymerization monomer and the hexafluoropropylene are controlled such that the polymerization monomer and the hexafluoropropylene are maintained at desired concentrations in the polymerization kettle.

17. The method of preparing a polyfluoroalkoxy resin of claim 11, wherein the obtained polyfluoroalkoxy resin is subjected to fluorination treatment, so that a number of unstable end groups is below 10.

18. A polyfluoroalkoxy resin, which is prepared by the method of preparing a polyfluoroalkoxy resin according to claim 1.

19. The polyfluoroalkoxy resin according to claim 18, wherein a melting point peak of the polyfluoroalkoxy resin is fractionated by successive self-nucleation and annealing fractionation into eight peaks, which are >317.5° C., 315±2.5° C., 310±2.5° C., 305±2.5° C., 300±2.5° C., 295±2.5° C., 290±2.5° C. and <287.5° C.; peak area of the melting point peak at >317.5° C. accounts for 10% to 35% of total peak area; peak area of the melting point peak at 315±2.5° C. accounts for 0.05% to 3% of the total peak area, peak area of the melting point peak at 310±2.5° C. accounts for 5% to 20% of the total peak area, a sum of the peak areas of the melting point peak at 305±2.5° C., 300±2.5° C., 295±2.5° C., 290±2.5° C. accounts for 35% to 70% of the total peak area, and peak area of the melting point peak at <287.5° C. accounts for 0.01% to 8% of the total peak area.

20. The polyfluoroalkoxy resin according to claim 18, wherein in the polyfluoroalkoxy resin, content of perfluoroalkyl vinyl ether is in a range from 3.0 wt % to 10.0 wt %, and content of hexafluoropropylene is in a range from 0.03 wt % to 1.0 wt %; a melt index of the polyfluoroalkoxy resin is in a range of 0.1 g/10 min to 80 g/10 min, and a melting point thereof is in a range from 280° C. to 310° C.
